(19) United States
(12) Patent Application Publication
(10) Pub. No.: US 2009/0037524 A1
(43) Pub. Date: Feb. 5, 2009

(54) METHOD AND APPARATUS TO GENERATE A MEDIA PRESENTATION

(75) Inventors: David Michael O'Rourke, San Jose, CA (US); Nick Brosnahan, Cupertino, CA (US); David Kramer, Cupertino, CA (US); Kjell Bronder, Cupertino, CA (US); Nathan Spindel, Cupertino, CA (US); Eric Circlaeys, Cupertino, CA (US)

Correspondence Address: SCHWEGMAN, LUNDBERG & WOESSNER/APPLE, PO BOX 2938, MINNEAPOLIS, MN, 55402, US

(73) Assignee: Apple Inc., Cupertino, CA (US)

(21) Appl. No.: 12/118,304

(22) Filed: May 9, 2008

Related U.S. Application Data
(60) Provisional application No. 60/953,877, filed on Aug. 3, 2007.

(51) Int. Cl. G06F 15/16; H04L 9/32; G06F 21/00; G06F 15/173

(52) U.S. Cl. 709/203; 709/208; 709/228; 709/223; 726/7

(57) ABSTRACT

Apparatus and methods to control media presentation provide capabilities to capture a media event and process the media content captured in a distributed arrangement. In an embodiment, a media client communicates with a media production server to conduct a media capture event and to process media content generated from the media capture event in which the media production server controls the media capture machine that generates the media content.

### BACKGROUND

Information provided in a multimedia format has become an important feature in the interplay among individuals in a modern society. Improvements to the flow of media data in the production of a multimedia presentation enhances one's ability to interact with others.

Visual information captured by cameras can be used to enhance informational presentations or various entertainment productions. As one example, video provided by cameras can be used to provide a lecture to individuals unable to attend the physical presentation of the lecture. As another example, captured video may be provided to editing equipment, so that portions of the video can be inserted into other video presentations. Such captured video may include audio corresponding to the images collected. In other examples, audio only can be captured in a recording and provided to individuals that are distant from the audio, substantially coincident with the generation of the audio or at a later date. Accordingly, inventive apparatus and methods provide, among other things, new structures and processes for capturing and processing video, audio, or combinations thereof.

### BRIEF DESCRIPTION OF THE DRAWINGS

Embodiments of the invention are illustrated by way of example and not limitation in the figures of the accompanying drawings in which:

FIG. 1 depicts a representation of an example architecture in which an embodiment of a media production server is incorporated.

FIG. 2 depicts features for flow of signals of an architecture that includes an embodiment of a media production server.

FIG. 3 depicts features of an architecture that includes an embodiment of a media production server.

FIG. 4 illustrates features of an embodiment of a method to conduct a media capture event and to process media content generated from the media capture event.

FIG. 5 illustrates features of an embodiment of a method using a media production server to conduct a media capture event and to process media content generated from the media capture event.

FIG. 6 illustrates features of an embodiment of a method using a command tool of a media client to initiate a media capture event and to submit media content generated from the media capture event.

FIG. 7 illustrates a block diagram of an example embodiment of a media production server, configured as a podcast producer server, in relationship to a camera capture agent.

FIG. 8 depicts features of an embodiment of a binding process between a podcast producer server and a camera capture agent.

FIG. 9 illustrates features of an embodiment of a method to submit a recording from a media capture agent to a media production server.

FIG. 10 illustrates features of an embodiment of a method to post-process media using a media production server.

FIG. 11 shows features of an embodiment of a method to provide a credential callback mechanism from a task agent to a media production server.

FIG. 12 depicts features of an embodiment of a method for a task agent to authenticate with a service.

FIG. 13 illustrates features of an embodiment of a method for providing a sliding window control for a recording time in a media capture agent.

FIG. 14 illustrates features of an embodiment of a method for generating a signal to control a recording time for operation of a media capture machine.

FIG. 15 shows features of an embodiment of a method for a media production server to monitor the status of media capture machines controllable by the media production server.

FIG. 16 shows features of an embodiment of a method for preparing to start a recording session in a media capture machine.

FIG. 17 shows features of an embodiment of a method for monitoring the recording status of a media capture machine.

FIG. 18 shows features of an embodiment to update a soft cutoff time for a recording session.

FIG. 19 shows a block diagram of an embodiment of a system, in accordance with various embodiments associated with a media production server, to capture media content of an event in which a media client initiates the media capture by a media capture machine that is controlled by a media production server.

### DETAILED DESCRIPTION

The following detailed description refers to the accompanying drawings that show, by way of illustration, details and embodiments in which the invention may be practiced. These embodiments are described in sufficient detail to enable those skilled in the art to practice embodiments of the present invention. Other embodiments may be utilized and structural, logical, and electrical changes may be made without departing from the inventive subject matter. The various embodiments disclosed herein are not necessarily mutually exclusive, as some embodiments can be combined with one or more other embodiments to form new embodiments. The following detailed description is, therefore, not to be taken in a limiting sense.

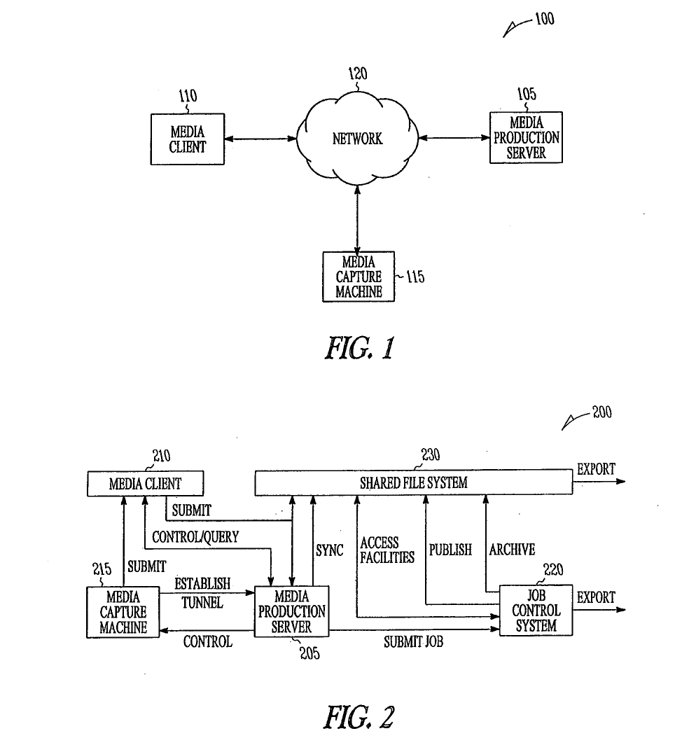

FIG. 1 depicts a representation of an example architecture 100 in which an embodiment of a media production server 105 is incorporated. A media production server is a system or apparatus in a client-server relationship with one or more entities to produce a media representation of an event, in which the system or apparatus operates in one or more activities correlated to media capture of the event, processing of media content from the capture activity, publishing the processed media content, or other associated activities. In an embodiment, media production server 105 can operatively communicate with a media client 110 and a media capture machine 115. Media production server 105 can control the operation of media capture machine 115 and manage the post-processing of media content generated by media capture machine 115. Post-processing refers to operations on the media content captured by a media capture machine. The media content may include video and audio content, video only content, audio only content, or other content that may be incorporated in a presentation. Media capture machine 115 may be one of a plurality of media capture machines controllable by media production server 105. Media capture machine 115 may be structured as a media capture system having a device to capture the media event and a control mechanism to interact with systems external to the device. Media client 110 initiates the start of a media capture event by media capture machine 115 under the control of media production server 105 and coordinates the submission of media content generated in the media capture event to media production server 105. In an embodiment, communication between media production server 105 and media capture machine 115 can be performed in a secure manner in which an encryption key or secret for the communication is obtained by media client 110 for use by media capture machine 115.

Media production server 105 can operatively communicate with media client 110 over a network 120. Media production server 105 can also operatively communicate with media capture machine 115 over network 120. Media production server 105 may communicate with media capture machine 115 over a network different from the network over which media production server 105 communicates with media client 110. In an embodiment, network 120 is an open network. An open network herein is a network that is not limited to a private network. Network 120 may include various combinations of open networks and private networks. Network 120 may be a local area network (LAN). Network 120 may be a wide area network (WAN). Network 120 may include a WAN and a LAN. Network 120 may include a wireless network.

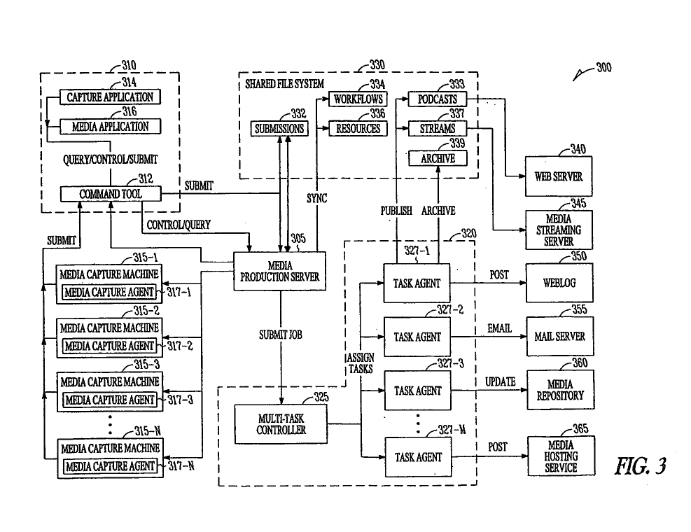

FIG. 2 depicts features for flow of signals of an architecture 200 that includes an embodiment of a media production server 205. Architecture 200 may be used in the architecture of FIG. 1 in which media production server 205 may be arranged as media production server 105. Media client 210 generates control and query signals to media production server 205 in the initiation phase of capturing a media event and processing the media content from the event. Media capture machine 215 establishes a communication tunnel with media production server 205, and media production server 205 uses the communication tunnel to generate commands to media capture machine 215 to control the media capture event. Media capture machine 215 submits the captured media content to the media client 210. Media capture machine 215 may be configured as a machine to capture video and audio content, video only content, audio only content, or other content that may be incorporated in a presentation. Media client 210 submits the media content to a shared file system 230 and media production server 205. Media production server submits a job to job control system 220 and synchronizes elements of shared file system 230, whose facilities are accessed by job control system 220 to process the media content. Results of the processing by job control system 220 are published and/or archived in shared file system 230. Results of the processing of the media content can be exported by job control system 220 and by shared file system 230.

FIG. 3 depicts features of an architecture 300 that includes an embodiment of a media production server 305. Architecture 300 may be used in the architectures of FIGS. 1 and 2 in which media production server 305 may be arranged similar to media production server 205 and/or 105. Architecture 300 provides a media capture, processing, and publishing arrangement. Media production server 305 manages multiple media capture machines, provides access control and centralized management, and accepts submitted media content to be further processed. Media production server 305 may be configured as one or more instrumentalities to control the operation of media capture machines and manage the post-processing of media content generated by media capture machines. The instrumentalities can be realized in hardware implementations, software implementations, and combinations of hardware and software implementations. Some portions of the instrumentalities may be described in terms of algorithms and symbolic representations of operations on data bits within a machine memory. An algorithm is herein, and generally, conceived to be a self-consistent sequence of actions leading to a desired result. The actions are those requiring physical manipulations of physical quantities. Usually, though not necessarily, these quantities take the form of electrical or magnetic signals capable of being stored, transferred, combined, compared, and otherwise manipulated. The instrumentalities may operate to process, compute, calculate, determine, display, and/or conduct other activities correlated to processes of a machine, such as a computer system or similar electronic computing device, that manipulates and transforms data represented as physical (electronic) quantities within the computer system's registers and memories into other data similarly represented as physical quantities within the computer system memories or registers or other such information storage, transmission or display devices. The instrumentalities may use distributed applications, different numbers and types of software based components that couple two or more applications to enable data transfer between the applications, hardware to provide services from a number of different sources, and may be realized on a variety of hardware platforms such as content management systems. The instrumentalities may include or provide access to subroutine code, code libraries, application program interfaces such as interpreters or other such electronic based functionalities.

Media production server 305 can operatively communicate with media client 310 and media capture machines 315-1, 315-2, 315-3 . . . 315-N. A communication conveyance is not shown in FIG. 3, but such a communication conveyance can be realized as a network as discussed with respect to FIG. 1. Media client 310 includes a command tool 312 as a user interface client that is a lower level client of media client 310. In an embodiment, command tool 312 provides the mechanism to access all query and control operations available on media production server 305. Media client 310 may include a capture application 314 and a media application 316 built on command tool 312. Command tool 312, capture application 314, and media application 316 may be integrated in a locally configured media client. Command tool 312, capture application 314, and media application 316 may be arranged in a distributed configuration. In a distributed configuration, command tool 312, capture application 314, and media application 316 may be located at various parts of a network, such as, but not limited to, network 120 of FIG. 1.

Capture application 314 includes a graphical user interface (GUI) application to provide users with the capability to initiate and complete capture of media content. The capture of media content provides a recording or a memorialization in a storage medium. Capture application 314 provides a user of media client 310 with the capability to define a media capture event. Through interaction of command tool 312 with media production server 305, capture application 314 initiates, controls, and completes capture of media content. The media content may include video, audio, text, or combinations thereof. Capture application 314 allows a user to set parameters in the capture and processing of media content of an event including metadata such as title and description of the media content. Metadata are various pieces of information from different sources that are associated with a capture of media content. Capture application 314 allows a user to choose from among a set of available workflows to be applied to the captured media content. The available workflows and associated parameters are provided from media production server 305 through queries from command tool 312.

In an embodiment, capture application 314 provides local screen capture as a content source. Capture application 314 may provide a mechanism to submit previously edited media files through direct file submission to media production server 305, which allows the use of various media editing software to submit media content, via capture application 314, to media production server 305. In an embodiment, capture application 314 is an application to generate and/or manage a podcast. A podcast episode typically refers to a digital media file, or set of digital media files, that is distributed over a network for playback. The network used for the distribution of a podcast includes, but is not limited to, the Internet. In general, digital media files typically contain audio content and/or video content, but can also include images, text, a file having Portable Document Format (PDF) as a file format, or any file type containing content to provide information or entertainment. The term podcast has also been used to mean the act to distribute (multimedia files) over the Internet for playback typically on a mobile device or a personal computer. Podcasting, typically, is an automatic mechanism whereby multimedia files are transferred from a server to a client. An entity that authors or hosts a podcast is referred to as a podcaster. In an embodiment, media production server 305 can be configured as a podcast producer server to capture video of an event, process the video content, and publish the processed video content to provide a podcast of the event.

Media application 316 provides a user of media client 310 with the capability to access multimedia content. The accessed multimedia content may be transmitted to media production server 305 via command tool 312. The accessed multimedia content may be correlated to a media capture event such that the accessed multimedia content can be partially incorporated, fully incorporated, or edited with media content in a post-processing of the media content through operation of the media production server 305. The multimedia content provided by media application 316 may include video content, audio content, text-type content, or combinations thereof.

Media capture machines 315-1, 315-2, 315-3 . . . 315-N controllable by media production server 305 include a variety of multimedia machines. The multimedia machines may include, but are not limited to, audio capture machines, video capture machines, machines to collect and manage documents, and combinations thereof. In an embodiment, media capture machines 315-1, 315-2, 315-3 . . . 315-N include cameras. Each media capture machine 315-1, 315-2, 315-3, . . . 315-N may interact with media production server through media capture agents 317-1, 317-2, 317-3, . . . 317-N, respectively. A media capture agent accepts and performs commands to stop and start the capture to control a media capture machine. In an embodiment, capture agents 317-1, 317-2, 317-3, . . . 317-N are configured as a single agent for media capture machines 315-1, 315-2, 315-3, . . . 315-N. An agent includes a software entity, or a software entity and its associated hardware, which is a set of instructions executable by a machine, capable of acting with a certain degree of autonomy in order to accomplish tasks on behalf of its user machine. An agent configured as a software entity and its associated hardware, such as machine-readable medium and controllers, may be referred to as an agent machine. An agent is typically defined in terms of its behavior and may execute its function based on the criteria contained within its instruction set. Agent code typically runs continuously to perform one or more activities based on its instructions without being executed directly on demand. Capabilities associated with agents include, but are not limited to, task selection, prioritization, goal-directed behaviour, decision-making without human intervention, engagement of other components through a form of communication and coordination. Agents typically analyze the context of activity in which they operate and react to it appropriately. Media capture agents 317-1, 317-2, 317-3 . . . 317-N may be incorporated in their associated media capture machines 315-1, 315-2, 315-3 . . . 315-N. Media capture agents 317-1, 317-2, 317-3 . . . 317-N may be agent machines separate but communicatively coupled with their associated media capture machines 315-1, 315-2, 315-3, . . . 315-N.

Architecture 300 includes a shared file system 330. Shared file system 330 includes submissions 332 that contains media content submitted via command tool 312 in response to completion of a media capture event by one or more of the media capture machines 315-1, 315-2, 315-3 . . . 315-N. Submission 332 may also collect metadata and associate it with the contained media content. In one example of the invention, submission 332 may collect metadata originating with one or more of possible sources, such as metadata: originating with media production server 305, such as that identifying the type of content presented; that originating with the user, such as the title and other specific identifying information, as discussed relative to capture application 314; and that originating from an administrative function, which might include, for example, publishing information. Command tool 312 may submit the media content as it is being acquired by the respective media capture machines 315-1, 315-2, 315-3 . . . 315-N. Shared file system 330 includes resources 336 that are resources to process the media content.

Shared file system 330 includes workflows 334. Workflows are encapsulated sets of instructions that are processed by media production server 305 and injected into job control system 320 to process submitted media files. Each workflow contains step-by-step instructions with variables that act as locations for replacement of data. The variables allow media production server 305 to customize execution of each workflow to the capture-specific metadata associated with the submitted media files. For example, one workflow may be selected to operate on media content from two different events. The variables allow the user the ability to replace a title and description variables, for example, with different titles and descriptions of the media content from the two different events. Properties of media production server 305 may also be used to replace the variables. Some variables may be automatically replaced by media production server 305, for example, a variable may be replaced automatically with the absolute location of where the media content files for a specific capture event may be found within shared file system 330.

Architecture 300 includes a job control system 320, where job control system 320 has a multi-task controller 325 and a number of task agents 327-1, 327-2, 327-3 . . . 327-M that are managed by multi-task controller 325. Task agents 327-1, 327-2, 327-3 . . . 327-M may be configured on respective task agent machines. Media production server 305 is operatively coupled to multi-task controller 325 to submit a job to multi-task controller 325 to work on post-processing of the media content. Multi-task controller 325 receives a job to execute, queues the jobs until task agents are available, and assigns the job, categorized into sections, to the appropriate task agent for each section. Task agents 327-1, 327-2, 327-3 . . . 327-M are bound to the multi-task controller that assigns the respective tasks to execute. In one example of the system, multi-task controller 325 will monitor available task agents and exclude those that are inappropriate for a specific task to be assigned. For example, multi-task controller 325 may check factors such as the operating system in the task agent, the availability of shared file system 330 to the agent, and the hardware configuration of the task agent to assure that the task agent is compatible and suitable for one or more tasks to be assigned. An example of one system and method suitable for this purpose is described in U.S. application Ser. No. 11/303,105, entitled Assigning Tasks In A Distributed System Based On Ranking, and filed Dec. 16, 2005, and assigned to the assignee of the present application, and which is hereby incorporated herein by reference for all purposes.

Though an archive 339 of shared file system 330 archives source material, copies of the results from job control system 320 may be archived in an archive 339 of shared file system 330. The results may also be published to podcast files 333 and/or stream files 337 in shared file system 330. Podcast files 333 provide an avenue to distribute the processed media content as podcasts to one or more web servers 340. Stream files 337 provide an avenue to distribute the processed media content as streaming media to one or more media streaming servers 345. Task agents 327-1, 327-2, 327-3 . . . 327-M can also post results to a weblog 350, e-mail results to a mail server 355, update a media repository 360, and post results to a media hosting service 365.

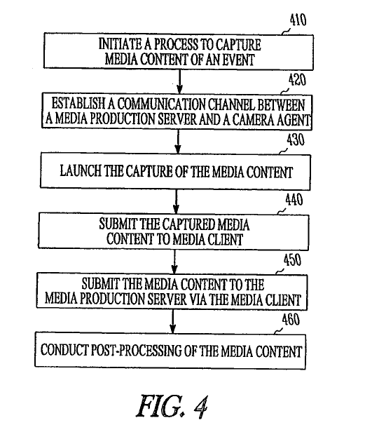

FIG. 4 illustrates features of an embodiment of a method to conduct a media capture event and to process media content generated from the media capture event. As example, the process may be described in terms of the architecture of FIG. 3 in which the media capture machine includes a camera machine. At 410, a process to capture media content of an event is initiated. Through use of capture application 314 of media client 310, a user can determine or select an event for which a video recording of the event is to be captured. In addition to the video of the event, the associated audio can be captured with the associated video. Video content, herein, may include audio content associated with the video. Through a graphical user interface of media client 310 a user can initiate the video recording. The user can supply a set of information for the event. Such information may include local administration credentials, selection of the camera machine 315 or other audio/video devices to be used, an identification of the camera agent 317 for the camera machine 315, an identification of a media production server 305 to be used, and administration credentials for access to media production server 305. Camera agent 317 accepts and performs various commands to stop and start the video capture to control camera machine 315. The identification of an entity may be accomplished through a name for the entity. The capture application 314 invokes command tool 312 to request operation of the camera machine 315 by media production server 305. The capture application 314 also stores the information supplied by the user.

At 420, a communication channel is established between media production server 305 and a camera agent 317. In an exchange of information, media production server 305 provides media client 310 with information to establish a communication channel between the camera agent 317 for camera machine 315 and media production server 305. The information is in the form of a secret for the camera agent 317 to setup a secure communication for media production server 305 to control camera machine 315 for the capture of the recording event. The secret may be an encryption key for joint use by camera agent 317 and media production server 305.

At 430, the capture of the media content is launched. With information exchange completed in a pre-capture phase, the user through capture application 314 can launch the recording by camera machine 315 through camera agent 317. The launch can include transmitting a command to media production server 305, which controls operation of media camera machine 315 over a persistent, encrypted connection to media production server 305 established by camera agent 317. The operation commands from media production server 305 include, but are not limited to, start, stop, pause, resume, and cancel a recording.

At 440, the captured media content is submitted to media client 310. Upon completion of the recording of the media event, video content from camera machine 315 is submitted to media production server 305 and to submissions 332 using command tool 312, which is part of media client 310. The submission of the video content to media production server 305 and submissions 332 may be performed automatically by the command tool 312 depending on its underlying instruction set. The described submission of the video content may be directed under control of the user through capture application 314. In addition, media application 316 can provide media content that may be incorporated with the video content in post-processing of the video content to generate a completed media presentation. Such incorporation in post-processing may include copying portions of the media content and editing the video content to include the portions at various sections of the video content. The media content from media application 316 can be submitted to media production server 305 via command tool 312.

At 450, the media content is submitted to the media production server 305 via the media client 310. The submission of the video content and/or other media content from command tool 312 to media production server 305 may be realized by transmitting the video content and/or other media content to the media production server 305. The submission may be realized as a notification of the completion of the camera recording of the event and a notification of the transmission of the video content and/or other media content to the submissions 332 section of shared file system 330. The location of the video content and/or other media content in submissions 332 section may be provided to media production server 305 by command tool 312. The location of the video content and/or other media content in submissions 332 section may be provided to command tool 312 by media production server 305 in an exchange of information upon the notification of the completion of the camera recording of the event. Shared file system 330 may provide the location of the video content and/or other media content in submissions 332 section upon the reception of this material along with appropriate identifying information and in an information exchange with command tool 312 and/or media production server 305. Various permutations of the manner of exchanging information on the storage of the video content and/or other media content may be realized.

At 460, post-processing of the media content is conducted. With media production server 305 notified of a submission and/or receiving the submission, media production server 305 provides a synchronization (sync) control of workflows 334 and resources 336 to generate post-processing of the media content by job control system 320. Media production server 305 submits a job to multi-task controller 325 to work on post-processing of the media content. The job is categorized into tasks by multi-task controller 325, which assigns the tasks to task agents 327-1, 327-2, 327-3 . . . 327-M. The results of task agents 327-1, 327-2, 327-3 . . . 327-M may be provided in various forms. Post-processing can be initiated by media production server 305 using workflows 334 and identified resources 336 in shared file system 330. Media production server 305 can submit a job to multi-task controller 325. Multi-task controller 325 may divide the job into one or more tasks that may be performed substantially independently. Tasks may include combining two or more results from a set of tasks accomplished to provide other results directed by the job submission. Multi-task controller 325 assigns the different tasks to different task agents 327-1 . . . 327-M, which operate on the media content according to its task function. The results from operation by task agents 327-1 . . . 327-M may be published to shared file system 330 and/or provided to external systems by posting, e-mailing, updating, or performing combinations of such transmissions.

FIG. 5 illustrates features of an embodiment of a method using a media production server to conduct a media capture event and to process media content generated from the media capture event. At 510, a media production server receives a request over a network from a media client to perform a media capture event using a media capture machine under control of the media production server. At 520, the media production server controls the media capture event performed by the media capture machine based on the received request. At 530, the media production server receives a submission of media content generated by the media capture event corresponding to the received request. At 540, the media production server controls the initiation of the post-processing of the received media content.

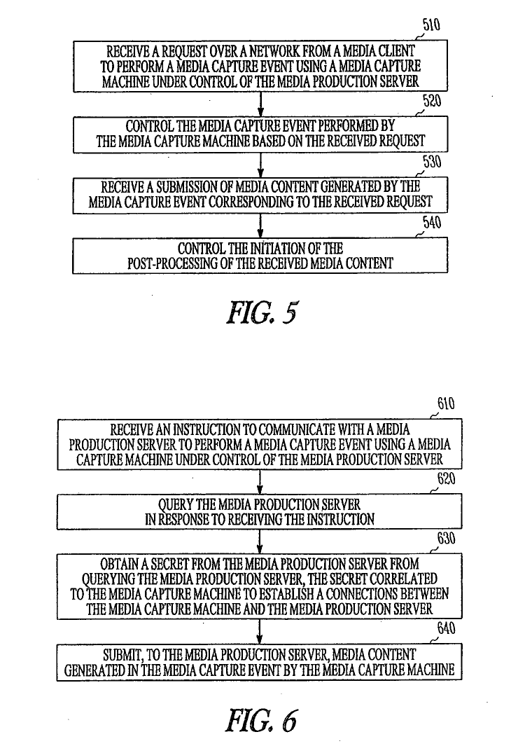

FIG. 6 illustrates features of an embodiment of a method using a command tool of a media client to initiate a media capture event and to submit media content generated from the media capture event. At 610, the command tool receives an instruction to communicate with a media production server to perform a media capture event using a media capture machine under control of the media production server. At 620, the command tool queries media production server in response to receiving the instruction. The queries include exchange of information. At 630, the command tool obtains a secret from the media production server from querying the media production server, where the secret is correlated to the media capture machine to establish a connection between the media capture machine and the media production server. At 640, the command tool submits, to the media production server, media content generated in the media capture event by the media capture machine.

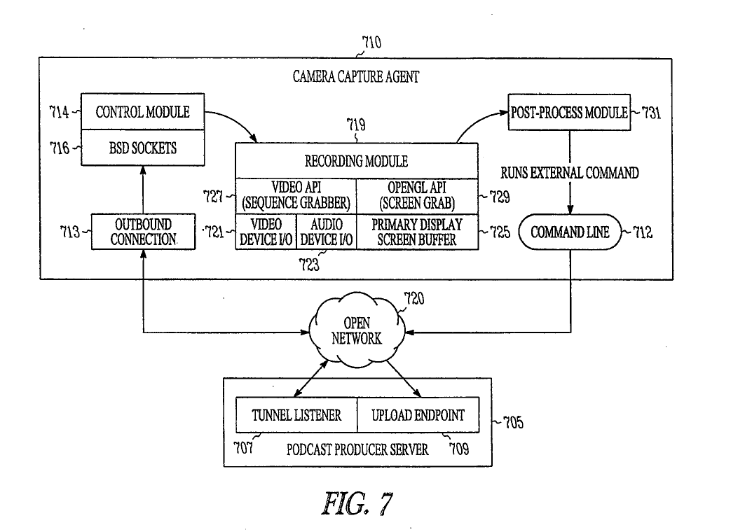

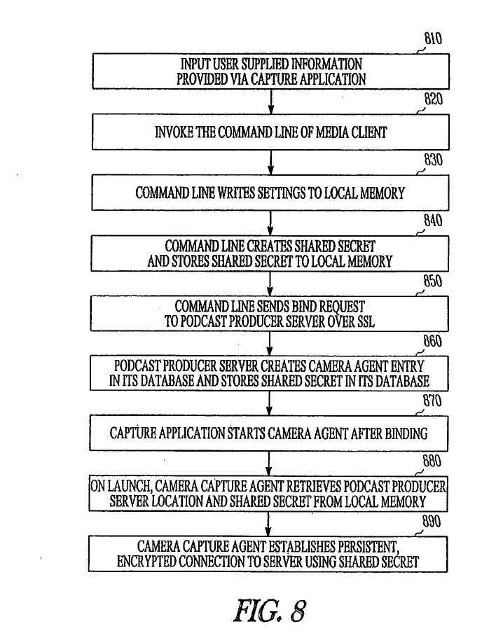

FIG. 7 illustrates a block diagram of an example embodiment of a media production server, configured as a podcast producer server 705, in relationship to a camera capture agent 710. Camera capture agent 710 can be configured as a daemon that runs on a camera agent machine. Podcast producer server 705 and camera capture agent 710 are operatively coupled over an open network 720. Camera capture agent 710 receives instructions from podcast producer server 705 to start, stop, pause, resume, or cancel video recordings. Each completed recording is uploaded back to the podcast producer server 705.

Camera capture agent 710 has an outbound connection 713 that receives commands from podcast producer server 705. Outbound connection 713 is a control tunnel that may be realized as an outbound transmission control protocol (TCP) connection from camera capture agent 710 to podcast producer server 705. The control tunnel is provided as an outbound connection to support placing camera capture agent 710 behind network address translated (NAT) routers. Camera capture agent 710 connects to podcast producer server 705 and waits for instructions or commands. The instructions may be initiated by authorized users that connect to podcast producer server 705 using a command tool of a media client (not shown in FIG. 7) or a graphical user interface of a capture application of a media client (not shown in FIG. 7). Commands are provided to control module 714 that implements the recording commands via a Berkeley sockets (BSD sockets) 716. Recordings are created on local recording module 719, such as a local recording disk. Camera capture agent 710 also includes video device input/output (I/O) 721, an audio device I/O 723, a primary display screen buffer 725, a video application program interface (API) 727, and an OpenGL API 729. The associated video and audio devices may be pre-configured. Post-process module 731 provides for uploading completed recordings back to podcast producer server 705. When the recordings are completed, they can automatically be submitted to the podcast producer server 705 for further processing. Post-process module 731 runs an external command to command line 712. Command line 712 is a low-level client that submits captured media content to podcast producer server 705. Command line 712 may upload completed recordings using file transfer protocol (FTP), secure hypertext transfer protocol (HTTPS), a copy command, or other mechanism.

Podcast producer server 705 provides an upload endpoint 709 for the recordings using FTP, hypertext transfer protocol HTTPS, a copy command, or other mechanism. Podcast producer server 705 includes a tunnel listener 707 to receive a signal from camera capture agent 710 to establish a connection for podcast producer server 705 to send commands to camera capture agent 710. Commands sent from podcast producer server 705 to camera capture agent 710 include starting, stopping, pausing, resuming, and canceling a recording. In an embodiment, camera capture agent 710 may only be configured and run by a user supplying appropriate local administrative credentials. An administrator on a media client machine may bind camera capture agent 710 to a specific podcast producer server 705. This binding mechanism establishes a shared secret between a specific camera capture agent 710 and a specific podcast producer server 705. Podcast producer server 705 maintains a list of camera agents along with their names, unique identifiers (UUIDs), and a shared secret for each camera agent. The exchange of this information may occur over a secure sockets layer (SSL) connection between the camera agent machine and the podcast producer server. The arrangement depicted in FIG. 7 may be applied to a relationship to other media production servers and media capture agents.

FIG. 8 depicts features of an embodiment of a bind process between a podcast producer server and a camera capture agent, such as the podcast producer server and the camera capture agent of FIG. 7. In such an embodiment, the binding process is the creation of a shared secret between the camera agent and the podcast producer server and the use of that shared secret. The use of the shared secret is conducted during the establishment of a network connection between the camera agent and the podcast producer server. The creation of a shared secret is conducted over SSL by a command tool on behalf of the camera agent, where the command tool is part of the media client that initiates the camera capture event. Information is exchanged and written out to the agent preferences on the camera agent machine. The use of the shared secret is conducted when the camera agent is started. It uses the stored information to create an encrypted tunnel with the podcast producer server over a TCP connection. The session over the TCP connection uses a symmetric AES (encrypted data for security) encryption using the shared secret previously acquired. A reconnection process may be initiated by the camera capture agent if the connection is terminated in response to an error message generated by the podcast producer server. Such a bind process, as described herein, may also be implemented for other media production servers and media capture agents.

At 810, a user supplies information through use of a user interface for a capture application. The information includes local administration credentials, selection of audio/video devices, camera agent name, name of podcast producer server as host, and administrative credentials for the podcast producer server. At 820, the command line of a media client is invoked. At 830, the command line writes settings to a local memory. At 840, the command line creates a shared secret and stores the shared secret to the local memory. At 850, command line sends a bind request to the podcast producer server over SSL. At 860, the podcast producer server creates a camera agent entry in its database and stores the shared secret in its database. The stored shared secret is different from the SSL. At 870, a capture application starts camera agent after binding with the podcast producer server. At 880, on launch, the capture agent retrieves the podcast producer server location and the shared secret from local memory. The podcast producer location information includes host/port of the podcast producer server. At 890, the camera capture agent establishes persistent, encrypted connection to server using the shared secret. A bind process may also be implemented for other media production servers and media capture agents.

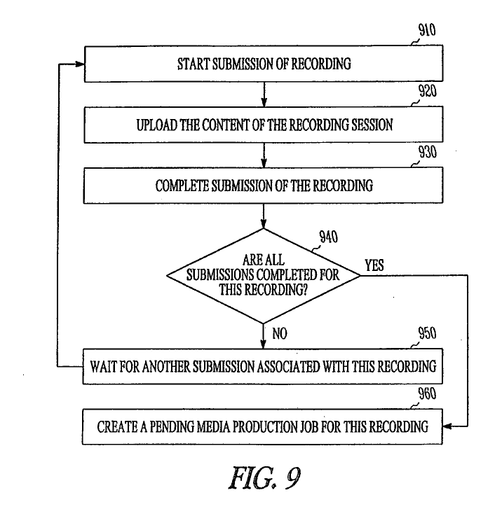

FIG. 9 illustrates features of an embodiment of a method to submit a recording from a media capture agent to a media production server. At 910, an indication is provided to start submission of recording. At 920, the content of the recording session is uploaded. Uploading recording content may be accompanied by metadata associated with the recording content. The upload process may use FTP, HTTPS, a copy command, or other transfer mechanism for this submission. At 930, the submission of the recording is completed. At 940, a determination is made as to whether or not all submissions have been completed for this recording. At 950, if all submissions have not been completed, wait for another submission associated with this recording and return to 910. At 960, if all submissions have been completed, a pending media production job is created for this recording. In an embodiment, the media production server is configured as a podcast producer server and the media capture agent is a camera capture agent.

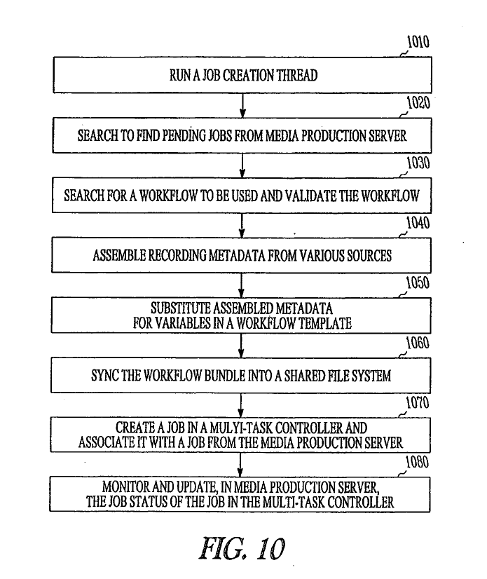

FIG. 10 illustrates features of an embodiment of a method to post-process media using a media production server. At 1010, a job creation thread is run. At 1020, a search to find pending jobs from media production server is conducted. At 1030, a search for a workflow to be used is performed and the workflow is validated. At 1040, recording metadata from various sources is assembled. At 1050, a template is processed from a workflow to substitute assembled metadata for variables of the template. Within a workflow template is a set of tasks to be performed, which may have sub-blocks of tasks. Each sub-block has a name and may have dependencies to other tasks. Each task has a command and a set of arguments. The property substitutions in the template allow the media production server to configure the output of the workflow based on user and administrator-defined properties for the specific recording being processed. At 1060, the workflow bundle is synced into shared file system.

At 1070, a job in a multi-task controller is created and associated with a job from the media production server. The multi-task controller assigns tasks to task agent machines from the submitted job and may perform such procedures as video transformations, transcoding, and auto extraction. Tasks defined in workflows and executed by task agents may include, but are not limited to, such tasks as unpack, encode, annotate, watermark, title, merge, update a media repository, send to media hosting service, mail, archive, publish, groupblog, template, and approval. Each action may be invoked by the command line. These actions can be chained together to process the media content files. The resulting processed content is published by a task agent to destinations defined in the workflow template. These destinations can include e-mail notifications, weblog postings, media hosting services, and other user-defined destinations. At 1080, the job status of the job in the multi-task controller is monitored and updated in the media production server. In an embodiment, the media production server is configured as a podcast producer server. The multi-task controller and the media production server may be structured in various embodiments according to the teaching described with respect to the previous Figures.

In an embodiment, a media production server may operatively communicate with a task agent to perform a callback mechanism to provide for communications, over a network, between the task agent and a system or service that requires an authentication. The task agent is the entity that is authenticating with the external system or service. Such authentication typically requires a username and password. The callback mechanism provides a procedure for the task agent to acquire a password to authenticate with the external system or service without the task agent maintaining user names, passwords, and service-based authentication procedures. The media production server can be configured to allow a one-time use password that permits the task agent to access the media production server to have a single authentication challenge performed. Such a procedure allows the user names and passwords to be kept completely within the media production server.

The callback mechanism may include embedding a one-time use password in the job submission by the media production server. The one-time use password extracted from the job information allows the task agent to access the media production server. In accessing the media production server, the task agent presents the one-time password and the challenge from the external system or service. The media production server validates the one-time password by looking up the one-time password and associated user name, which are administratively stored and kept secret. The callback mechanism may be considered to be a credential callback mechanism or a credential service. The media production server performs the calculation necessary to respond properly to the challenge from the external system or service. The determined response is provided to the task agent, which uses the response to the challenge to authenticate to the external system or service. The callback from the task agent directly accesses the media production server rather than communicating back through the task controller, which is an alternative procedure. For each external system or service that requires an authentication with the task agent, the media production server may contain the various authentication methods to address the challenges from these systems or services. The media production server and the task agent may be configured according to any of the embodiments described herein.

FIG. 11 shows features of an embodiment of a method to provide a credential callback mechanism from a task agent to a media production server. At 1110, a one-time password is stored in a database accessible by a media production server, where the one-time password corresponds to a job task executed by a task agent. The media production server may embed the one-time password in the specification for a job task provided to the task agent via a multi-task controller. The job task may be generated as a processing of a media file captured by a media capture machine under the control of the media production server. At 1120, the media production server receives an authentication challenge that has been received by the task agent from a service. The task agent may send the authentication challenge directly to the media production server. At 1130, a version of a one-time password is received from the task agent along with the authentication challenge. At 1140, the version of the one-time password from the task agent is validated as being the one-time password stored in the database. At 1150, a response to the challenge is calculated. At 1160, the response to the challenge is provided to the task agent. The response to the challenge can be transmitted over a network to the service from the task agent to complete authorization of the task agent with the service. In various embodiments, task agents and media production servers, as taught herein, may be configured to operate with each other in authentication sessions with other services and systems.

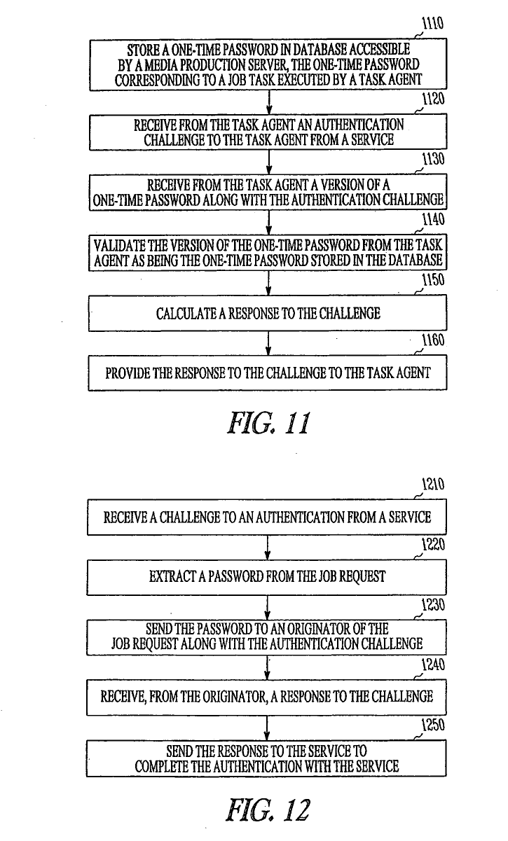

FIG. 12 depicts features of an embodiment of a method for a task agent to authenticate with a service. At 1210, a challenge to an authentication with a service is received from the service. The authentication may be requested by the service for a task agent to access the service to provide the service with results of a job task that the task agent has completed. At 1220, a password is extracted from a job request. The task agent can be configured to execute tasks while maintaining limited information on the source or sources that provide job tasks to the task agent. With the password included in a job request, in which the password is embedded in the information used to perform the task, the task agent does not need to maintain passwords and other data on the sources that generate the task. In addition to the embedded password, a job request may include the identity of the originator for a task agent that is not tied to a single originator. A media production server may include the password and job name with the job submitted to a multi-task controller that can provide the password to each task agent assigned a portion of the submitted job. The passing of the password may be limited to those task agents that conduct conveyance of its results to services that use an authentication process. The password may be tied to the job request such that it is a one-time password.

At 1230, the password is sent to an originator of the job request along with the challenge. A task agent can send the password directly to a media production server without being processed by the multi-task controller that controls the task agent. At 1240, a response to the challenge is received from the originator. With a media production server having access to the authentication procedures of services with which the task agents communicate, media production server can calculate a response to the authentication challenge from the service. The response to the challenge can be sent directly to the task agent without processing by the multi-task controller that manages the task agent. At 1250, the response is sent to the service to complete the authentication with the service. With the authentication challenge received as a result of activity by task agent to send results of a job request, the use of the password is related to the job request. The embedded password can be embedded as a one-time password corresponding to an identification of the job request. With a different job request, the task agent has a different one-time password to solicit aid, for addressing an authentication challenge, from the media production server that originated the job request. In various embodiments, task agents and media production servers, as taught herein, may be configured to operate with each other in authentication sessions with other services and systems.

FIG. 13 illustrates features of an embodiment of a method for providing a sliding window control for a recording time in a media capture agent. The sliding window control adjusts the recording time for a media capture machine, corresponding to the media capture agent, to capture media content of an event. At 1310, a soft-cutoff time is set in the media capture agent for a media capture machine to record the event. The soft cutoff may be administered as an updateable time at which a recording event should be terminated. A hard-cutoff time for recording the event is set such that the recording will terminate at the hard-cutoff time regardless of the status of the event. The hard-cutoff time may be provided as a fixed time period. The hard-cutoff time may be provided as an actual time relative to a system clock. The hard cut-off time can be monitored relative to a current time in recording the event. In an embodiment, the soft cutoff may be set as a length of time for recording an event.

At 1320, the soft-cutoff time in the media capture agent is updated by a fixed time period in response to receiving a status request from a media production server. The soft-cutoff time can be updated by adding a fixed time period to the soft-cutoff time to generate a new soft-cutoff time in response to receiving the status request from the media production server. In an embodiment, with the soft-cutoff set as a length of time for recording an event, the soft-cutoff time is updated by adding a fixed time period to the length of time for recording the event. A status request may be received periodically. In an embodiment, the status request is received at regular intervals.

The status request is received via a communication tunnel established between the media capture agent and the media production server such that the media production server controls the recording of the event, while the communication channel is established by the media capture agent. A current status of recording the event can be reported to the media production server.

In an embodiment, a fixed time period used for updating the soft cutoff can be modified. The modification can be provided to the media capture agent from the media production server. In addition, during recording of the event, monitoring a level of available storage space to store recorded data can be monitored to stop recording the event when a threshold level in the storage space is reached. Various embodiments for media capture machines, media capture agents, media clients, and media production servers may be arranged to implement an embodiment of a sliding window recording procedure.

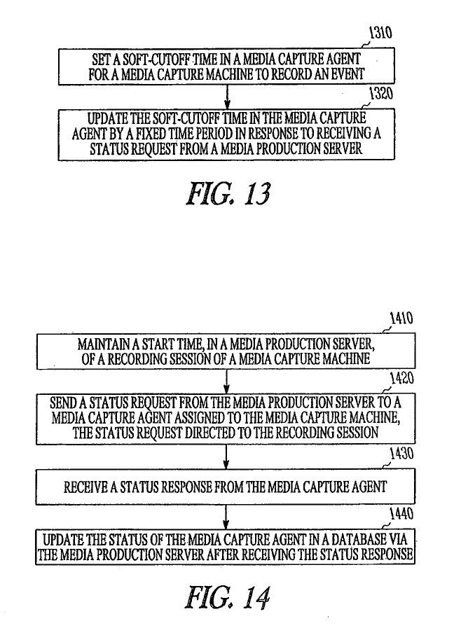

FIG. 14 illustrates features of an embodiment of a method for generating a signal to control a recording time for operation of a media capture machine. At 1410, a start time of a recording session of a media capture machine is maintained in a media production server. At 1420, a status request is sent from the media production server to a media capture agent assigned to the media capture machine, where the status request is directed to the recording session. The status request can be sent to the media capture agent periodically, such as once every minute during the recording session. The status request can be sent over a communication channel established by the media capture agent. The status request can be used by the media capture agent to control an update of a time to terminate the recording session. At 1430, the media production server receives a status response from the media capture agent. At 1440, the media production server updates the status of the media capture agent in a database after receiving the status response.

In an embodiment, a media production server controls a media capture agent in which a mechanism is provided such that, at the occurrence of a loss of communication between the two entities, the media production server maintains at least some control of a recording by a media capture machine corresponding to the media capture agent. Such a mechanism may be described, for example, in terms of features of the entities associated with the architectures of FIGS. 2-3. A media capture agent 317 may be considered to be in a recording lease with media production server 305 for capturing an event in a media format using a media capture machine 315 in which media capture agent 317 is basically slaved to media production server 305 during the recording of the event. Media capture agent 317 receives instructions from media production server 305 to perform operations such as starting, stopping, pausing, resuming, and canceling a recording. Media production server 305 also sets a length of time for the recording of the event at the outset of the use of media capture agent 317 to record the event. In addition, media capture agent 317 receives a signal from media production server 305 that is used to ensure that, once a recording is started, that media production server 305 maintains at least some control of the recording even if communication connectivity with media capture agent 317 is lost. The signal may be used to extend the recording time up to a fixed maximum time limit so that recording is not limited to the initial time, even if communications with media production server 305 are dropped. Such a mechanism also removes time restrictions on a user conducting the capture of the event on media. The media capture event, such as video of a lecture, a business meeting, or other such event may extend some time beyond a scheduled event end time, as many such events do, without additional activity to extend the capture of the event. A maximum time to which automatic time extension may occur may be set in the media production server 305.

Media production server 305 can, in a continual fashion, update its view of the status of media capture machine 315 by issuing status requests to media capture agent 317. The status request may inquire to the current status of the media capture machine 315 and/or its media capture agent 317. The status request is not limited to requesting status of a recording. Media capture agent 317 may reply by providing its current status, whether or not an associated media capture machine is recording, the length of time that the associated media capture machine has been recording, and other status information. Such information may be provided in a variety of formats.

In an embodiment, the status request generated by media production server 305 to media capture agent 317 can be used to provide a sliding window of time for recording an event while a media capture machine is conducting the recording. Each time that media capture agent 317 receives a status request it bumps the window to a future time at which media capture agent 317 will stop on its own if capture agent 317 loses communication with media production server 305. At the onset of the recording event, media production server 305 may set parameters for media capture agent 317 including a maximum time for recording and a time for the sliding window. With the occurrence of a loss of connectivity in communications from media production server 305 to media capture agent 317, the parameters set at the media capture agent 317 by media production server 305 control the recording. This is accomplished by providing that the recording must stop at the maximum time limit, but that the recording may continue to a time corresponding to sliding window, if the time corresponding to sliding window is less than the maximum time. For example, a video recording may be set to have a maximum recording of 4 hours from the start of recording or be set to record for 1 hour once it has lost connectivity with media production server 305. The 1 hour set from loss of connectivity is restricted such that the total recording time is less than or equal to the maximum sending of 4 hours. Use of 4 hours and 1 hour is provided as an example, other maximum times and sliding windows may be used. The selection of the maximum time may depend on the capacity of a media capture machine to record or other capacities of the hardware used in the media capture event. The sliding window time may depend on the application for which the media capture machine is being used.

Various factors may be used to determine a maximum record time. For instance, a media capture machine may have limited amount of storage medium on which to store the recording. In addition to running out of storage space for actual media storage, an additional amount of storage space may be used in the procedure to transfer the media content from the media capture machine to the storage medium. A maximum record time may be set to avoid occurrence of a state in which the captured video could not be off loaded to a storage medium. The storage medium may be realized as any medium for electronically or optically storing data. Since the maximum time is correlated to a time at which media capture agent 317 must cut-off the recording event, this maximum time is a hard-cutoff time. The hard-cutoff time may be represented as an actual time set or as a length of recording time. With the hard cut-off time set as a length of recording time, media capture agent may use data on the start of the recording and the time periods at which the recording is paused or halted to determine the actual time to stop the recording. In an embodiment, media capture agent 317 and its associated media capture machine 315 may be configured to monitor the time at which media capture machine records and collects data regarding on and off periods of time during the scheduled recording. Such a configuration allows media capture agent 317 to determine local periods of recording inactivity that may have occurred without being controlled by media production server 305.

In an embodiment, if a recording terminates at a time earlier than expected, the media capture agent can direct the automatic uploading of the captured media content to media production server 305. The upload may be transmitted in a manner as discussed with respect to submitting media content in the architecture of FIG. 3. A termination may include terminating the recording based on media capture agent 317 monitoring the storage space and determining that the recording should be terminated.

In an embodiment, each time a media capture agent 317 receives a status request from media production server 305, it updates its sliding recording lease. In such a manner, the media production server 305 initiates the update. Though media capture agent 317 receives a status request from media production server 305, it is capture agent 317 that connects to media production server 305. With media production server issuing all of the commands to media capture agent 317, the communication arrangement may be considered as a tunnel where media capture agent 317 connects to media production server 305 and opens the tunnel such that media production server 305 issues requests across the tunnel back to media capture agent 317. The status requests from media production server 305 to media capture agent 317 may be issued in a periodic manner. The period for issuing the status request is maintained by media production server 305 and may be adjusted administratively at media production server 305 or through an application that uses media production server 305 to record the event. In an embodiment, the status request is sent every minute. Other polling time periods may be used by media production server 305. Alternatively, media production server 305 may issue the status request on a random basis or in a manner controlled by an application initiating the control activity of media production server 305.

In an embodiment, a size of the sliding window is set in media capture agent 317 that defines a soft-cutoff time. The media production server 305, configured with a default polling period such as one minute, checks with media capture agent 317 once a minute. Each time that media capture agent 317 receives a request from media production server 305, media capture agent 317 takes the time of the status request and adds to it, the size of the window to generate a new stop time. The new stop time becomes the soft-cutoff time. Alternatively, the sliding window may be viewed as a soft-cutoff time that is added to a running time. In an embodiment, one hour may be set as a default size of the sliding window. In an embodiment, media capture agent 317 may be configured to sense a loss of communication connectivity with media production server 305 and apply the size of the sliding window to the time that the loss of connectivity is determined.

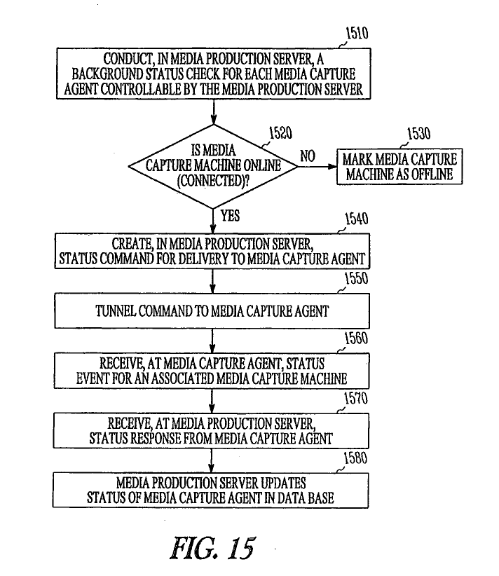

FIG. 15 shows features of an embodiment of a method for a media production server to monitor the status of media capture machines controllable by the media production server. At 1510, a media production server conducts a background status check for each media capture agent controllable by the media production server. At 1520, a determination is made as to whether or not the media capture machine is online (connected). At 1530, if the media capture machine is not online, the media capture machine is marked as offline. At 1540, if the media capture machine is online, the media production server creates a status command for delivery to the media capture agent. At 1550, the status command is tunneled to the media capture agent. At 1560, the media capture agent receives a status event for an associated media capture machine. At 1570, the media production server receives a status response from the media capture agent. At 1580, the media production server updates the status of media capture agent in database.

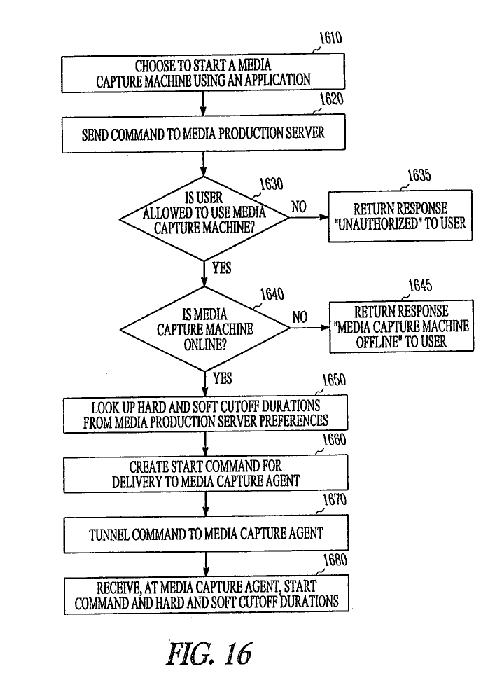

FIG. 16 shows features of an embodiment of a method for preparing to start a recording session in a media capture machine. At 1610, a user chooses to start a media capture machine using a capture application in a media client to a media production server. At 1620, a command is sent to the media production server from the media client. At 1630, a determination is made as to whether or not the user is allowed to use the media capture machine or whether it is in use by another authorized user. At 1635, if the user is not allowed to use the media capture machine, the response “unauthorized” is returned to the user. At 1640, if the user is allowed to use the media capture machine, a determination is made as to whether or not the media capture machine is online. At 1645, if the media capture machine is not online, the response “media capture machine offline” is returned to the user. At 1650, if the media capture machine is online, the media production server looks up the hard and soft cutoff durations from the media production server preferences. At 1660, the media production server creates a start command for delivery to media capture agent. At 1670, the command is tunneled to the media capture agent. At 1680, the media capture agent receives the start command along with hard and soft cutoff durations.

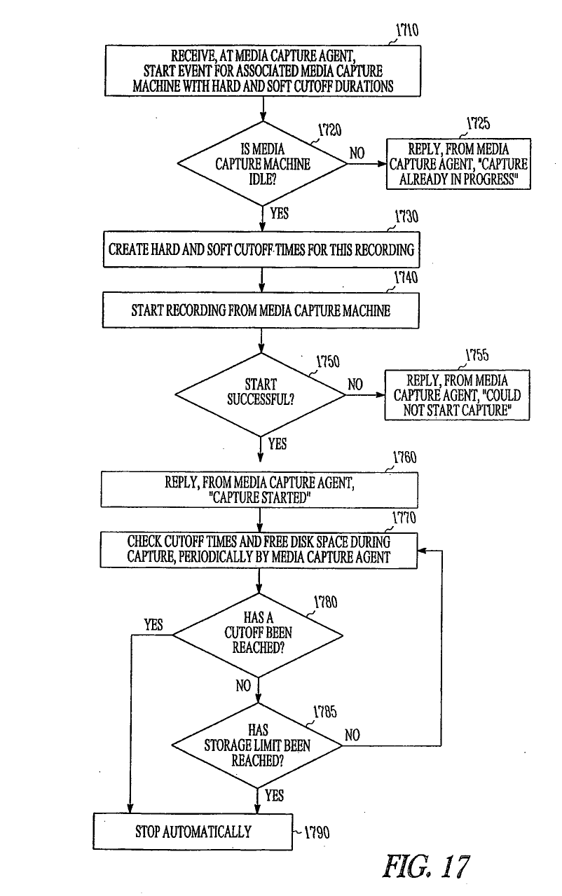

FIG. 17 shows features of an embodiment of a method for monitoring the recording status of a media capture machine. At 1710, a media capture agent receives a start event from a media production server for an associated media capture machine including hard and soft cutoff durations for operating the associated media capture machine. At 1720, a determination is made as to whether or not the associated media capture machine is idle. At 1725, if the media capture machine is not idle, the media capture agent replies “Capture already in progress.” At 1730, if the media capture machine is idle, the media capture agent creates hard and soft cutoff times for the recording corresponding to the received start event. At 1740, the associated media capture machine starts to record. At 1750, a determination is made as to whether or not the start is successful. At 1755, if the start is not successful, the media capture agent replies “Could not start capture.” At 1760, if the start is successful, the media capture agent replies “Capture started.” At 1770, during capture, the media capture agent periodically checks the cutoff times and the free disk space. The checks may be at one-minute intervals. At 1780, a determination is made as to whether or not a cutoff has been reached. If a cutoff has not been reached, at 1785, a determination is made as to whether or not a storage limit has been reached. If the storage limit has not been reached, the media capture agent periodically checks the cutoff times and the free disk space, at 1770. At 1790, if a cutoff has been reached or if the storage limit has been reached, the recording is automatically stopped.

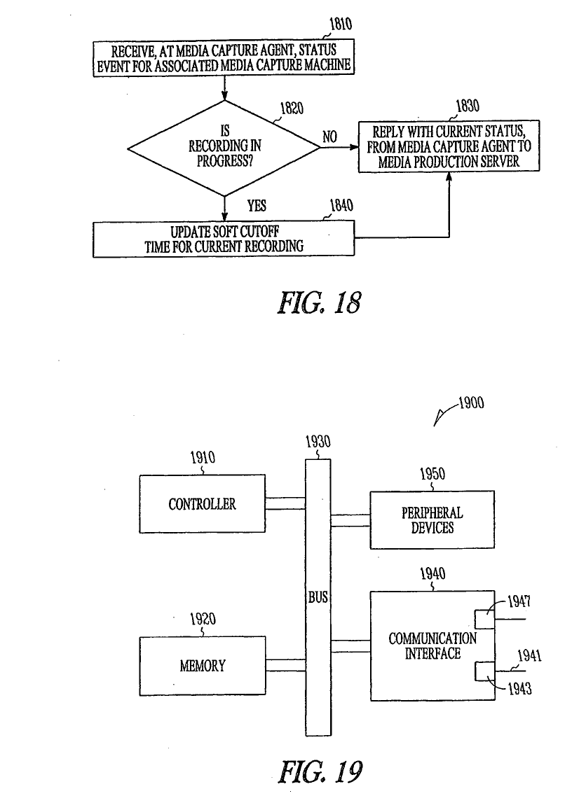

FIG. 18 shows features of an embodiment to update a soft cutoff time for a recording session. At 1810, a status event, such as a status request, from a media production server is received at a media capture agent for a media capture machine associated with the media capture agent. At 1820, a determination is made as to whether or not a recording is in progress. At 1830, if no recording is in progress, the media capture agent replies to the media production server with its current status. At 1840, if recording is in progress, the media capture agent updates a soft cutoff time for the current recording and reports its status to the media production server.

FIG. 19 shows a block diagram of an embodiment of a system 1900, in accordance with various embodiments associated with a media production server, to capture media content of an event in which a media client initiates the media capture by a media capture machine that is controlled by the media production server. System 1900 may be realized in one or more of a media client machine, a media capture machine, a media capture agent machine, a media production server, a job control system, a database system, or combinations thereof. System 1900 includes a controller 1910 and a memory 1920. Controller 1910 may include one or more processors. Memory 1920 stores instructions that can be executed by controller 1910. The instructions include instructions to controller 1910 to operate in a media capture event. The instructions include instructions to controller 1910 to operate at least a portion of memory 1920 as a database. Memory 1920 can store instructions, data, and other information. Memory 1920 may be realized as a storage medium in various electronic formats, magnetic formats, optical formats, or combinations thereof.

System 1900 may also include a communication interface 1940 and peripheral devices 1950. Controller 1910, memory 1920, communication interface 1940, and peripheral devices 1950 can be communicatively coupled among each other by a bus 1930. Bus 1930 may include an address, a data bus, and a control bus, each independently configured. Alternatively, bus 1930 may use common conductive lines for providing one or more of address, data, or control, the use of which may be regulated by controller 1910. Bus 1930 may provide a set of individual independent connections between the various components of 1900.

Peripheral devices 1950 may include one or more displays, alphanumeric input devices, cursor controls, memories, or other control devices that may operate in conjunction with one or more of controller 1910, memory 1920, and communication interface 1940. In various embodiments, communication unit 1940 may include a connection 1947 to couple to an antenna. In various embodiments, communication unit 1940 may include a connection 1943 to couple to a transmission medium 1941. Transmission medium 1941 may be an optical fiber medium. Transmission medium 1941 may couple to a wired network. Transmission medium 1941 may be cable. Transmission medium 1941 may include a coaxial cable, an unshielded twisted pair cable, or a shielded twisted pair cable. Communication interface 1940 may include one or more networks interfaces to communicate over various networks.

Various embodiments or combination of embodiments for apparatus and methods, as described herein, can be realized in hardware implementations, software implementations, and combinations of hardware and software implementations. These implementations may include a machine-readable medium having machine-executable instructions, such as a computer-readable medium having computer-executable instructions, for performing various embodiments associated with the capture and processing of media content of an event under the control of a media production server. The machine-readable medium is not limited to any one type of medium. The machine-readable medium used will depend on the application using an embodiment of a media production server.

Although specific embodiments have been illustrated and described herein, it will be appreciated by those of ordinary skill in the art that any arrangement that is calculated to achieve the same purpose may be substituted for the specific embodiments shown. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description.

What is claimed is:

1. A system, comprising:
a server configured to control a media capture machine in response to an input from a media client, the server operable to communicate with the media capture machine over a network.

2. The system of claim 1, wherein the server is further configured to communicate with the media capture machine over the network according to a security convention.

3. The system of claim 1, wherein the server is configured to receive media content from the media client.

4. The system of claim 1, wherein the system comprises one or more media capture agents; and wherein the server comprises a list of one or more media capture agents, the list including a unique identifier for each media capture machine and a secret for each media capture agent.

5. The system of claim 4, wherein at least one media capture agent comprises a camera capture agent.

6. The system of claim 1, wherein the server is configured to communicate with the media capture machine via a secure sockets layer (SSL) connection based on an encryption key delivered to the media client.

7. The method of claim 1, wherein the server is further configured to send a command to the media capture machine through use of a connection initiated by the media capture machine.

8. The system of claim 1, wherein the network comprises a wide area network (WAN).

9. The system of claim 1, wherein the network comprises a local area network (LAN).

10. The system of claim 1, wherein the server is operable with a task controller, the task controller configured to split a job from the server into a plurality of tasks and to manage a plurality of task agents to perform the plurality of tasks.

11. The system of claim 10, wherein the server is configured to synchronize data from the media client to a workflow in a shared file system, the workflow accessible by the task agents, accessibility being based on an authorization.

12. The system of claim 10, wherein one or more of the task agents are configured to provide a processed task to one or more other servers selected from a group including a weblog server, a mail server, an open-access media server, and a dedicated media server.

13. The system of claim 10, wherein one or more of the task agents are configured to publish a processed task to a shared file system.

14. The system of claim 13, wherein the shared file system is configured to provide the processed task to a web server or a media streaming server.

15. The system of claim 1, wherein the system further comprises:
a command tool integrated in the media client, the command tool to interact with the server;
a shared file system having a workflow, the workflow accessible by the server to act in reference to metadata corresponding to media content generated by the media capture machine; and
a job control system to post-process the media content generated by the media capture machine, the job control system having a multi-task controller and a number of task agents responsive to the multi-task controller to perform job tasks associated with the media content.

16. The system of claim 15, wherein the command tool, the shared file system, the server, and the job control system are arranged in a distributed configuration.

17. The system of claim 15, wherein the shared file system is configured to provide a processed task to a web server or a media streaming server.

18. A method, comprising:
receiving a request over a network from a media client to perform a media capture event using a media capture machine under control of a media production server;
controlling the media capture event performed by the media capture machine based on the received request;
receiving media content generated by the media capture event corresponding to the received request; and
controlling the initiation of post-processing the received media content.

19. The method of claim 18, wherein the network comprises an open network.

20. The method of claim 18, wherein receiving the request over the network comprises receiving the request via a secure communication.

21. The method of claim 20, wherein the method further comprises, in response to receiving the request, establishing an identity of the media capture machine and generating a secret operable to establish a secure communication connection between the media capture machine and the media production server.

22. The method of claim 21, wherein the method further comprises storing the identity of the media capture machine and the secret in a database.

23. The method of claim 18, wherein the method further comprises sending a set of preferences to the media client, the set of preferences correlated to information about a set of media capture machines controllable by the media production server.

24. The method of claim 18, wherein controlling the media capture event comprises sending a command to a media capture agent of the media capture machine, the command selected from a list including start, stop, pause, resume, and cancel.

25. The method of claim 18, wherein controlling the initiation of post-processing the received media content comprises customizing the workflow in a shared file system in reference to metadata associated with the media content.

26. The method of claim 18, wherein controlling the initiation of post-processing the received media content comprises submitting a job to a multi-task controller, the job correlated to the media content.

27. The method of claim 26, wherein the method further comprises monitoring progress of execution of said job.

28. A machine-readable medium that stores instructions, which when performed by a machine, cause the machine to perform operations comprising:
responding to a request received at a media production server from an authorized media client to perform a media capture event using a media capture machine under control of the media production server, the request received over a network;
controlling the media capture event performed by the media capture machine based on the received request;
receiving media content generated by the media capture event corresponding to the received request; and
controlling initiation of post-processing the received media content.

29. The machine-readable medium of claim 28, wherein the instructions, when performed by a machine, cause the machine to perform operations further comprising conducting reception of the request from an open network.

30. The machine-readable medium of claim 28, wherein the instructions, when performed by a machine, cause the machine to perform operations further comprising receiving the request via a secure communication.

31. The machine-readable medium of claim 30, wherein the instructions, when performed by a machine, cause the machine to perform operations further comprising:
in response to receiving the request, establishing an identity of the media capture machine, and
generating a secret operable to establish a secure communication connection with the media capture machine.

32. The machine-readable medium of claim 28, wherein the instructions, when performed by a machine, cause the machine to perform operations further comprising sending a set of preferences to the media client, the set of preferences correlated to information on a set of controllable media capture machines.

33. The machine-readable medium of claim 28, wherein the instructions that when performed by a machine cause the machine to perform operations comprising controlling the media capture event further result in operations comprising sending a command to a media capture agent of the media capture machine, the command selected from a list including start, stop, pause, resume, and cancel.

34. The machine-readable medium of claim 28, wherein the instructions, when performed by a machine, cause the machine to perform operations further comprising customizing a workflow in a shared file system, to metadata associated with the media content.

35. The machine-readable medium of claim 28, wherein the instructions, when performed by a machine, cause the machine to perform operations further comprising controlling the initiation of post-processing the received media content comprise one or more instructions to submit a job to a multi-task controller, the job correlated to the media content.

36. The machine-readable medium of claim 35, wherein the instructions, when performed by a machine, cause the machine to perform operations further comprising monitoring progress of execution of the job under the control of the multi-task controller.

37. A method, comprising:
receiving an instruction to communicate with a media production server to perform a media capture event using a media capture machine under control of the media production server;
querying the media production server;
receiving a secret from the media production server, the secret correlated to the media capture machine to establish a connection between the media capture machine and the media production server; and
submitting, to the media production server, media content generated in the media capture event by the media capture machine.

38. The method of claim 37, wherein submitting, to the media production server, media content comprises coordinating transmission of the media content from the media capture machine to the media production server or to a file system accessible by the media production server.

39. The method of claim 37, wherein querying the media production server in response to receiving the instruction comprises querying the media production server to select the media capture machine from a plurality of media capture machines under control of the media production server.

40. The method of claim 37, wherein the method further comprises submitting, to the media production server, media content not generated by the media capture machine.

41. The method of claim 37, wherein the method further comprises:
saving settings in a storage area, the settings correlated to the media capture event and the media capture machine; and
storing the secret in the storage area.

42. The method of claim 41, wherein the method further comprises:
accessing the secret in the storage area;
establishing a connection with the media production server using the secret; and
generating the media content using the media capture machine.

43. The method of claim 37, wherein the method further comprises conducting interactive communications with the media production server over an open network.

44. A machine-readable medium that stores instructions, which when performed by a machine, cause the machine to perform operations comprising:
querying a media production server in response to receiving an instruction to communicate with the media production server to perform a media capture event using a media capture machine under control of the media production server the instruction;
obtaining a secret from the media production server in the querying of the media production server, the secret correlated to the media capture machine to establish a connection between the media capture machine and the media production server; and
submitting, to the media production server, media content generated in the media capture event by the media capture machine.

45. The machine-readable medium of claim 44, wherein the instructions, when performed by a machine, which cause the machine to perform the operation of submitting to the media production server media content, further cause the machine to perform the operation of coordinating transmission of the media content from at least one of the media capture machine to the media production server, and the media capture machine to a file system accessible by the media production server.

46. The machine-readable medium of claim 44, wherein the instructions, when performed by a machine, which cause the machine to perform operations comprising querying the media production server, further cause the machine to perform the operation of querying the media production server to select the media capture machine from a plurality of media capture machines under control of the media production server.

47. The machine-readable medium of claim 44, wherein the instructions further comprise one or more instructions that, when performed by a machine, cause the machine to perform operations comprising submitting to the media production server, media content not generated by the media capture machine.

48. The machine-readable medium of claim 44, wherein the instructions further comprise one or more instructions that, when performed by a machine, cause the machine to perform operations comprising:
creating settings in a storage area, the settings correlated to the media capture event and the media capture machine; and
storing the secret in the storage area.

49. The machine-readable medium of claim 48, wherein the instructions further comprise one or more instructions that, when performed by a machine, cause the machine to perform operations comprising:
accessing the secret in the storage area;
establishing a connection with the media production server using the secret; and
generating the media content using the media capture machine.

50. The machine-readable medium of claim 44, wherein the instructions further comprise one or more instructions that, when performed by a machine, cause the machine to perform operations comprising interactively communicating with the media production server over an open network.

51. A system comprising:
a controller;
a command tool operable with the controller, the command tool operable to receive an instruction to communicate with a media production server to perform a media capture event using a media capture machine under control of the media production server, the command tool having stored instructions, the stored instructions when performed in conjunction with the controller cause the controller to:
query the media production server in response to receiving the instruction;
obtain a secret from the media production server in the querying of the media production server, the secret correlated to the media capture machine to establish a connection between the media capture machine and the media production server; and
submit, to the media production server, media content generated in the media capture event by the media capture machine; and
a display to present a representation of processing between the command tool and the media production server, the processing being associated with the media capture event.

52. The system of claim 51, wherein the command tool is configured to operatively obtain a secret to establish a secure connection between the media production server and a media agent of the media capture machine.

53. The system of claim 51, wherein the command tool is configured to select the media capture machine from a list of media capture machines controlled by the media production server, the list accessible from the media production server.

54. The system of claim 51, wherein the command tool is configured to coordinate transmission of the media content from at least one of, the media capture machine to the media production server, and the media capture machine to a file system accessible by the media production server.

55. A method comprising:
setting a soft-cutoff time in a media capture agent for a media capture machine to record an event; and
updating the soft-cutoff time in the media capture agent by a fixed time period in response to receiving a status request from a media production server.

56. The method of claim 55, wherein the method further comprises setting a hard-cutoff time to record the event, the hard-cutoff time determining an end to the recording event regardless of the status of the event.

57. The method of claim 55, wherein the method further comprises establishing a communication channel between the media capture agent and the media production server such that the media production server controls the recording of the event, the communication channel established by the media capture agent.

58. The method of claim 55, wherein updating the soft-cutoff time comprises adding the fixed time period to the soft-cutoff time to generate a new soft-cutoff time in response to receiving the status request from the media production server.

59. The method of claim 55, wherein setting a soft-cutoff time comprises setting a length of time for recording the event.

60. The method of claim 59, wherein updating the soft-cutoff time comprises adding the fixed time period to the length of time for recording the event.

61. The method of claim 55, wherein the method further comprises receiving, in the media capture agent, data to modify the fixed time period.

62. The method of claim 55, wherein the method further comprises monitoring the hard cut-off time relative to a current time in recording the event.

63. The method of claim 55, wherein the method further comprises:
during recording of the event, monitoring a level of available storage space to store recorded data: and
stopping recording of the event when a threshold level in the storage space is reached.

64. The method of claim 55, wherein the method further comprises reporting a current status of recording the event to the media production server.

65. A machine readable medium containing instructions, which when implemented by a machine, cause the machine to perform operations, comprising:
setting a soft-cutoff time in a storage area associated with a media capture agent for a media capture machine to record an event; and
updating the soft-cutoff time by fixed time period in response to reception of a status request from a media production server.

66. The machine readable medium of claim 65, wherein the instructions comprise one or more instructions that, when performed by a machine, cause the machine to perform operations further comprising setting a hard-cutoff time to record the event, the hard-cutoff time determining an end to the recording of the event regardless of the status of the event.

67. The machine readable medium of claim 65, wherein the instructions comprise one or more instructions that, when performed by a machine, cause the machine to perform operations further comprising establishing, prior to the recording of the event, a communication channel between the media capture agent and the media production server such that the media production server controls the recording of the event, the communication channel established by the media capture agent.

68. The machine readable medium of claim 65, wherein the instructions comprise one or more instructions that, when performed by a machine, cause the machine to perform operations further comprising adding the fixed time period to the soft-cutoff time to generate a new soft-cutoff time in response to reception of the status request from the media production server.

69. The machine readable medium of claim 65, wherein the instructions further comprise one or more instructions that, when performed by a machine, cause the machine to perform operations further comprising setting a length of time for the recording of the event.

70. The machine readable medium of claim 69, wherein the instructions comprise one or more instructions that, when performed by a machine, cause the machine to perform operations further comprising adding the fixed time period to the length of time for the recording of the event.

71. The machine readable medium of claim 65, wherein the instructions comprise one or more instructions that, when performed by a machine, cause the machine to perform operations further comprising modifying the fixed time period to update the soft-cutoff time.

72. The machine readable medium of claim 65, wherein the instructions comprise one or more instructions that, when performed by a machine, cause the machine to perform operations further comprising monitoring the hard cut-off time relative to a current time in the recording of the event.

73. The machine readable medium of claim 65, wherein the instructions comprise one or more instructions that, when performed by a machine, cause the machine to perform operations further comprising monitoring, during the recording of the event, a level of available storage space to store recorded data to stop the recording of the event upon attainment of a threshold level in the storage space.

74. The machine readable medium of claim 65, wherein the instructions comprise one or more instructions that, when performed by a machine, cause the machine to perform operations further comprising reporting a current status of the recording of the event to the media production server.

75. An apparatus comprising:
a controller;
a media capture agent operable with the controller to manage a media capture machine, the media capture agent comprising a machine readable media having stored instructions, the stored instructions when performed in conjunction with the controller cause the controller to:
set a soft-cutoff time in a storage area associated with a media capture agent for a media capture machine to record an event; and
update the soft-cutoff time by fixed time period in response to reception of a status request from a media production server.

76. The apparatus of claim 75, wherein the instructions further comprise one or more instructions to set a hard-cutoff time to record the event, the hard-cutoff time to determine an end to the recording of the event regardless of the status of the event.

77. The apparatus of claim 75, wherein the instructions further comprise one or more instructions to establish, prior to the recording of the event, a communication channel between the media capture agent and the media production server such the media production server controls the recording of the event, the communication channel established by the media capture agent.

78. The apparatus of claim 75, wherein instruction to update the soft-cutoff time comprises one or more instructions to add the fixed time period to the soft-cutoff time to generate a new soft-cutoff time in response to reception of the status request from the media production server.

79. The apparatus of claim 75, wherein the instructions further comprise one or more instructions to monitor the hard cut-off time relative to a current time in the recording of the event.

80. The apparatus of claim 75, wherein instructions further comprise one or more instructions to report a current status of the recording of the event to the media production server.

81. A method comprising:
maintaining a start time, in a media production server, of a recording session of a media capture machine;
sending a status request from the media production server to a media capture agent assigned to the media capture machine, the status request directed to the recording session;
receiving a status response from the media capture agent; and
updating a status of the media capture agent in a database via the media production server after receiving the status response.

82. The method of claim 81, wherein sending the status request comprises sending the status request periodically.

83. The method of claim 81, wherein sending the status request periodically comprises sending the status request once every minute during the recording session.

84. The method of claim 81, wherein the method further comprises communicating on a channel established by the media capture agent.

85. A machine readable medium containing instructions, which when implemented by a machine, cause the machine to perform operations, comprising:
maintaining a start time, in a media production server, of a recording session of a media capture machine;
sending a status request from the media production server to a media capture agent assigned to the media capture machine, the status request directed to the recording session; and
managing reception of a status response from the media capture agent; and
updating status of the media capture agent in a database via the media production server after reception of the status response.

86. The machine-readable medium of claim 85, wherein the instructions comprise one or more instructions that, when performed by a machine, cause the machine to perform operations further comprising sending the status request periodically.

87. The machine-readable medium of claim 86, wherein the operation of sending the status request periodically comprises sending the status request once every minute during the recording session.

88. The machine-readable medium of claim 85, wherein the instructions comprise one or more instructions that, when performed by a machine, cause the machine to perform operations further comprising responding to the media capture agent to establish a communication link to control the recording session.

89. A system comprising:
a media production server, the media production server comprising,
a controller;
a machine-readable medium containing instructions, which when executed by the controller, cause the controller to perform operations in the system, comprising:
maintaining a start time, in the media production server, of a recording session of a media capture machine;
sending a status request from the media production server to a media capture agent assigned to the media capture machine, the status request directed to the recording session;
managing reception of a status response from the media capture agent; and
updating status of the media capture agent in a database after reception of the status response.

90. The system of claim 89, wherein the operation of sending the status request comprises sending the status request periodically.

91. The machine-readable medium of claim 90, wherein sending the status request periodically comprises sending the status request once every minute during the recording session.

92. The machine-readable medium of claim 89, wherein the instructions comprise one or more instructions that, when performed by a machine, cause the machine to perform operations further comprising responding to the media capture agent to establish a communication link to control the recording session.

93. A method comprising:
storing a one-time password in a database accessible by a media production server, the one-time password corresponding to a job task executed by a task agent;
receiving from the task agent an authentication challenge to the task agent from a service;
receiving from the task agent a version of a one-time password along with the authentication challenge;
validating the version of the one-time password from the task agent as being the one-time password stored in the database;
calculating a response to the challenge; and
sending the response to the challenge to the task agent.

94. The method of claim 93, wherein the method further comprises generating the job task as a processing of a media file captured by a media capture machine under the control of the media production server.

95. The method of claim 93, wherein the method further comprises transmitting the response to the challenge over a network to the service from the task agent.

96. A method comprising:
receiving a challenge to an authentication from a service;
extracting a password from a job request;
sending the password to an originator of the job request;
receiving, from the originator, a response to the challenge;
sending the response to the service to complete the authentication with the service.

97. The method of claim 96, wherein receiving the challenge to the authentication from the service comprises receiving the challenge at a task agent assigned to execute a task for the job request.

98. The method of claim 96, wherein sending the password to an originator of the job request comprises sending the password to a media production server that generated the job request.

99. The method of claim 96, wherein extracting a password from a job request comprises extracting the password as a one-time password corresponding to an identification of the job request.
